(19) United States
(12) Patent Application Publication
(10) Pub. No.: US 2025/0217922 A1
(43) Pub. Date: Jul. 3, 2025

(54) TASK PROCESSING METHOD AND DEVICE

(71) Applicant: Lenovo (Beijing) Limited, Beijing (CN)

(72) Inventors: Hao ZHONG, Beijing (CN); Zebin ZHENG, Beijing (CN); Zhuang GUO, Beijing (CN)

(21) Appl. No.: 19/001,775

(22) Filed: Dec. 26, 2024

(30) Foreign Application Priority Data
Dec. 29, 2023 (CN) 202311869502.3

(51) Int. Cl. G06T 1/20

(52) U.S. Cl. CPC G06T 1/20

(57) ABSTRACT

A task processing method includes: in response to a first electronic device in a target device cluster obtaining a target processing task triggered by a target application, establishing a target communication connection with at least one second electronic device determined from the target device cluster; and sending a first part of the target processing task to the at least one second electronic device through the target communication connection, such that the at least one second electronic device processes the first part of the target processing task. The first part of the target processing task is the remaining task in the target processing task except a second part of the target processing task processed by the first electronic device, and the target device cluster is a resource cluster including multiple electronic devices.

### CROSS-REFERENCE TO RELATED APPLICATION

This application claims priority to Chinese Patent Application No. 202311869502.3, filed on Dec. 29, 2023, and the entire content of which is incorporated herein by reference.

### TECHNICAL FIELD

The present disclosure relates to the technical field of computer technologies, and more particularly, to a task processing method and a device thereof.

### BACKGROUND

A graphics processing unit (GPU) is a specialized image processing chip. But the GPU is widely used not only in image processing, but also in scientific computing, password cracking, numerical analysis, big data processing, financial analysis, and other fields that require computing. On a personal computer (PC), the GPU undertakes the main image processing and computing tasks.

With the continuous development of cloud computing, big data, artificial intelligence, and 5G communication technology, local computing needs are growing exponentially, and the GPU computing power in a local PC is difficult to satisfy the corresponding computing power requirements. Therefore, how to complete tasks that require large computing power has become an urgent problem to be solved.

### SUMMARY

One aspect of the present disclosure provides a task processing method. The task processing method includes: in response to a first electronic device in a target device cluster obtaining a target processing task triggered by a target application, establishing a target communication connection with at least one second electronic device determined from the target device cluster; and sending a first part of the target processing task to the at least one second electronic device through the target communication connection, such that the at least one second electronic device processes the first part of the target processing task. The first part of the target processing task is the remaining task in the target processing task except a second part of the target processing task processed by the first electronic device, and the target device cluster is a resource cluster including multiple electronic devices.

Another aspect of the present disclosure provides a task processing device. The task processing device includes a memory storing program instructions and a processor coupled to the memory. When being executed the processor, the program instructions cause the processor to: in response to a first electronic device in a target device cluster obtaining a target processing task triggered by a target application, establish a target communication connection with at least one second electronic device determined from the target device cluster; and send a first part of the target processing task to the at least one second electronic device through the target communication connection, such that the at least one second electronic device processes the first part of the target processing task. The first part of the target processing task is the remaining task in the target processing task except a second part of the target processing task processed by the first electronic device, and the target device cluster is a resource cluster including multiple electronic devices.

Another aspect of the present disclosure provides a computer-readable storage medium storing computer instructions. When being executed by a processor, the computer instructions cause the process to: in response to a first electronic device in a target device cluster obtaining a target processing task triggered by a target application, establish a target communication connection with at least one second electronic device determined from the target device cluster; and send a first part of the target processing task to the at least one second electronic device through the target communication connection, such that the at least one second electronic device processes the first part of the target processing task. The first part of the target processing task is the remaining task in the target processing task except a second part of the target processing task processed by the first electronic device, and the target device cluster is a resource cluster including multiple electronic devices.

### BRIEF DESCRIPTION OF THE DRAWINGS

The drawings are not necessarily drawn to scale. The same reference numerals in the drawings may describe similar parts in different views. The drawings generally illustrate examples of various embodiments rather than limitations. Together with the specification and claims, the drawings serve to illustrate the disclosed embodiments. When appropriate, the same reference numerals are used throughout the drawings to refer to the same or similar parts. The embodiments of the apparatus or method are illustrative and are not intended to be exhaustive or exclusive.

FIG. 1 is a flowchart of a task processing method according to some embodiments of the present disclosure;

FIG. 2 is a schematic structural diagram of a target device cluster in a task processing method according to some embodiments of the present disclosure;

FIG. 3 is a schematic diagram of applying a task processing method in coordinating a first electronic device and a second electronic device to process a target processing task according to some embodiments of the present disclosure;

FIG. 4 is a schematic structural diagram of another target device cluster in a task processing method according to some embodiments of the present disclosure;

FIG. 5 is a timing diagram of a task processing method according to some embodiments of the present disclosure;

FIG. 6 is a flowchart of performing a target processing task by a task processing method according to some embodiments of the present disclosure;

FIG. 7 is a schematic diagram of applying a task processing method in coordinating a task machine and a collaboration machine to process a target processing task according to some embodiments of the present disclosure;

FIG. 8 is a flowchart of another task processing method according to some embodiments of the present disclosure;

FIG. 9 is a timing diagram of another task processing method according to some embodiments of the present disclosure;

FIG. 10 is a schematic structural diagram of a task processing system for performing a task processing method according to some embodiments of the present disclosure;

FIG. 11 is a schematic diagram of a software architecture of a task processing method according to some embodiments of the present disclosure;

FIG. 12 is a schematic structural diagram of a task processing device according to some embodiments of the present disclosure; and

FIG. 13 is a schematic diagram of a hardware architecture of a computer device according to some embodiments of the present disclosure;

### DETAILED DESCRIPTION OF THE EMBODIMENTS

To clearly and completely describe the technical solutions in the embodiments of the present application, the present disclosure is described in detail below in conjunction with the drawings and specific implementation methods. Obviously, the described embodiments are merely part of the embodiments of the present disclosure, not all of the embodiments. Based on the embodiments in the present disclosure, all other embodiments obtained by ordinary people skilled in the art without creative work are within the scope of protection of the present disclosure.

In the following description, “some embodiments” are used to describe a subset of all possible embodiments, but it can be understood that “some embodiments” can be the same subset or different subsets of all possible embodiments, and can be combined with each other without conflict.

The terms “first/second/third” are only used to distinguish similar objects, and do not represent a specific order for the objects. It can be understood that “first/second/third” can be interchanged with a specific order or sequence where permitted, such that the embodiments of the present disclosure described herein can be implemented in an order other than that illustrated or described here.

Unless otherwise defined, all technical and scientific terms used in this specification have the same meaning as those generally understood by those skilled in the art of the present disclosure. The terms used in this specification are merely for the purpose of describing the present disclosure and are not intended to limit the present disclosure.

To better understand the task processing method provided in the embodiments of the present disclosure, the task processing scheme adopted in the relevant technology is first described below.

In the related technology, to handle tasks with large computing power requirements, the following technical solutions are proposed.

In Solution 1, NV-Link communication is used at a single server to achieve bridging of multiple GPUs on the single server to complete the processing of tasks with large computing power requirements.

However, using NV-Link to achieve bridging of multiple GPUs on a client-side PC often places high requirements on the hardware such as the graphics card, the motherboard and the power supply of the client-side PC, which is difficult to implement.

At the same time, the unified computing device architecture (CUDA) and model-driven data analytics (MDDA) specifications used on the client-side PC only allow the client-side PC to access the local GPU, and do not directly provide access interfaces to remote GPUs. This results in multiple GPU resources on multiple PCs being unable to assist each other, resulting in idle computing power.

In Solution 2, a client-edge cloud architecture is established, where the computing tasks of the client-side PC may be completed by cloud servers and edge servers, thereby solving the problem of limited computing power of the client-side PC.

However, using the client-edge cloud architecture to achieve task processing requires paying high cloud fees, and data security may not be guaranteed when transmitting data over the network.

In Solution 3, Docker container technology is used to package the application and its dependencies into a lightweight, portable container, thereby distributing tasks to multiple computer nodes for processing.

However, the Docker container technology requires a large amount of resources, and a container is not suitable for running visualization and scenarios that require a user interface (UI) interaction with users. Thus, it is not suitable for deployment on PCs.

Based on this, the present disclosure provides a task processing method, which can be executed by a processor of a computer device. The computer device may refer to a device with data processing capabilities such as a laptop, a tablet computer, a desktop computer, a smart TV, a mobile device (such as a mobile phone, a portable video player, a personal digital assistant, a dedicated messaging device, a portable gaming device).

FIG. 1 is a flowchart of a task processing method according to some embodiments of the present disclosure. As shown in FIG. 1, the method includes the following processes.

At S101, in response to a first electronic device in a target device cluster obtaining a target processing task triggered by a target application, a target communication connection is established with at least one second electronic device determined from the target device cluster.

Here, the target device cluster is a device cluster including multiple electronic devices. The multiple electronic devices may be a device cluster including personal computers (PCs), or may be a device cluster including some PCs and some cloud servers.

In some embodiments, the target device cluster is constructed by forming a local area network among the multiple electronic devices.

In some embodiments, the target device cluster is constructed among the multiple electronic devices through a connection method such as the Internet.

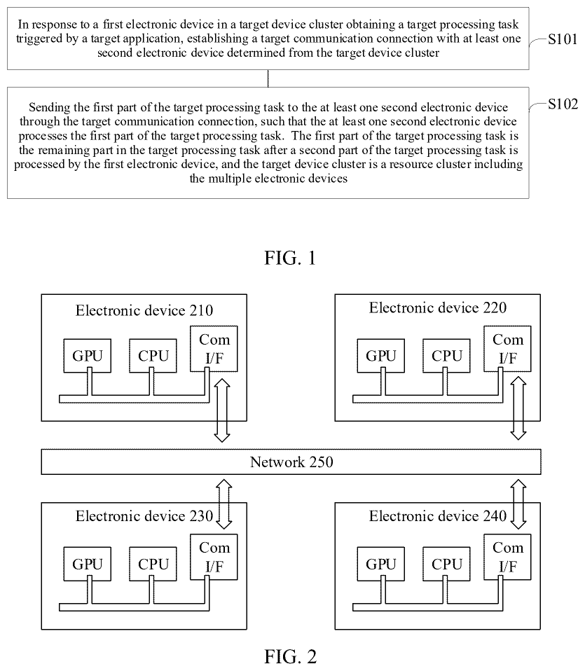

In some embodiments, as shown in FIG. 2, electronic devices 210, 220, 230, and 240 are connected with each other through a network 250 to form the device cluster. In the device cluster, each electronic device includes a corresponding central processing unit (CPU), a graphics processing unit (GPU), and a communication interface.

The first electronic device represents a device that generates the target processing task to be processed, that is, in a task processing, the first electronic device is a task machine that generates the target processing task in the target cluster.

The second electronic device represents a device that assists the first electronic device in completing at least part of the target processing task by using configured hardware processing resources such as computing processing resources, graphics rendering resources, etc., that is, in the task processing, the second electronic device is a collaboration machine that assists in executing tasks in the target cluster.

The target application is an application running on the first electronic device, which triggers the corresponding target processing task. For example, when the target application is a drawing application or a game application, the target processing task triggered by it is an image rendering task. When the target application is a financial analysis-related application, the target processing task triggered by it is a scientific computing task.

In some embodiments, the target processing task is a task that requires the use of a GPU resource of one of the multiple electronic devices to perform the image rendering task or the scientific computing task.

The target communication connection refers to a communication connection established between the first electronic device and the at least one second electronic device for transmitting a first part of the target processing task.

Here, the target communication connection may be a network connection or a cable connection established between the first electronic device and each second electronic device.

In some embodiments, the first electronic device may directly establish the target communication connection with each second electronic device.

In some embodiments, the first electronic device may establish the target communication connection with each second electronic device based on control information of a master device in the target device cluster.

At S102, the first part of the target processing task is sent to the at least one second electronic device through the target communication connection, such that the at least one second electronic device processes the first part of the target processing task. The first part of the target processing task is the remaining part in the target processing task after a second part of the target processing task is processed by the first electronic device, and the target device cluster is a resource cluster including the multiple electronic devices.

Here, the target processing task is analyzed and split to obtain the first part of the target processing task and the second part of the target processing task. The first part of the target processing task is processed by the first electronic device using local hardware resources and/or software resources, and the second part of the target processing task is processed by the at least one second electronic device using its configured hardware resources and/or software resources.

In some embodiments, when the target processing task is split into the first part of the target processing task and the second part of the target processing task, a task amount of the first part of the target processing task and another task amount of the second part of the target processing task are determined respectively based on available hardware resources and/or software resources in the first electronic device and the at least one second electronic device.

In some embodiments, the first electronic device determines the task amount of the first part of the target processing task and the task amount of the second part of the target processing task.

In some embodiments, the task amount of the first part of the target processing task and the task amount of the second part of the target processing task are determined by the master device in the target device cluster.

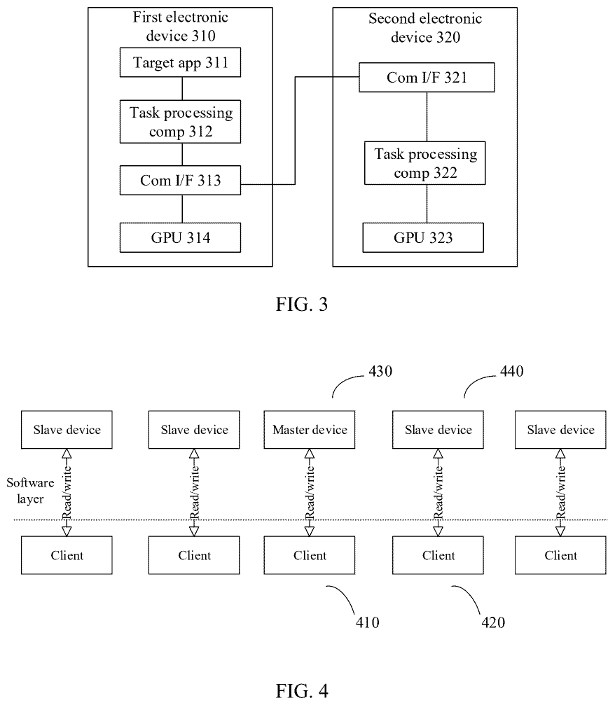

FIG. 3 is a schematic diagram of applying a task processing method in coordinating a first electronic device and a second electronic device to process a target processing task according to some embodiments of the present disclosure.

As shown in FIG. 3, the target application 311 in the first electronic device 310 triggers the target processing task. The target processing task is sent to a task processing component 312 to determine a processing capacity (such as the amount of calculation) required for the target processing task. When it is determined that the device resource situation of the first electronic device 310 cannot meet the amount of calculation required for the target processing task, the first part of the target processing task is sent to a communication interface 321 of the second electronic device 320 through a communication interface 313 of the first electronic device 310, and the second part of the target processing task is sent to a GPU 314 of the first electronic device 310 for processing. After receiving the first part of the target processing task, the second electronic device 320 transmits the first part of the target processing task to a task processing component 322, and the task processing component 322 generates a GPU driving instruction. The GPU driving instruction generated by the task processing component 322 is sent to a GPU 323, such that the GPU 323 executes the first part of the target processing task.

In the task processing method provided in the present disclosure, the first electronic device sends the first part of the target processing task to the at least one second electronic device in the target device cluster, such that the at least one second electronic device processes the first part of the target processing task. As such, processing resources of remote electronic devices are used to assist in completing a local target processing task. When the computing power of local electronic devices is limited, the target processing task to be processed with large computing power requirements may still be completed without the need to upgrade the local electronic devices or pay high costs for cloud computing. Using the multiple electronic devices to complete the target processing task simultaneously may improve a processing efficiency of the target processing task. For computing-intensive tasks such as large-scale data processing and deep learning training, the computing resources of the multiple electronic devices are used for parallel and/or serial computing, which can significantly improve the processing efficiency of the target task processing. In addition, the multiple electronic devices in the target device cluster may be connected directly or through the master device, that is, the connection method is simple, so the multiple electronic devices in the target device cluster can be dynamically expanded or adjusted based on the task computing requirements to improve the overall computing power of the target device cluster without redesigning the target device cluster system architecture.

In some embodiments, the target device cluster uses a monitoring mechanism (a watch mechanism) to monitor data transmission between the multiple electronic devices in the cluster. That is, when the data transmission changes in the target device cluster, the change will be notified to a client registered for monitoring in the watch mechanism to achieve timely notification of data.

In some embodiments, the task processing method provided by the present disclosure further includes the following process.

At S103, a task processing request is sent to a third electronic device to determine the at least one second electronic device capable of processing the task processing request through the third electronic device. The third electronic device is a device determined from the target device cluster.

Here, the third electronic device represents an electronic device in the target device cluster for performing resource allocation, that is, the third device is the master device.

In some embodiments, each electronic device in the target device cluster sends local information and a device resource status to the third electronic device. The device resource status includes device resource configuration condition and device resource usage condition, such that the third electronic device can determine the at least one second electronic device based on the device resource status of each electronic device in the target device cluster. For example, each electronic device in the target device cluster sends local media access control (MAC) address information, Internet protocol (IP) address information, hardware configuration information, GPU resource condition, etc. to the third electronic device.

In some embodiments, the third electronic device may be one of the other electronic devices in the target device cluster except the first electronic device.

In the case where the third electronic device is one of the multiple electronic devices in the target device cluster, the third electronic device may be determined from the target device cluster through a predetermined election mechanism. In some embodiments, an electronic device with the least device resource usage in the target device cluster is determined as the third electronic device. In some other embodiments, a device with the weakest or strongest GPU computing power in the target device cluster is determined as the third electronic device.

As shown in FIG. 4, in the target device cluster formed by forming a local area network with 5 clients (electronic devices), each client (electronic device) corresponds to a slave device (collaboration machine) or the master device (i.e., the third electronic device) in the software layer. For example, client 410 corresponds to master device 430 in the software layer;

client 420 corresponds to slave device 440 in the software layer. In some embodiments, when the master device is elected through an election mechanism, each client broadcasts the resource usage of the local machine in the local area network by sending a UDP broadcast, thereby electing a client with more idle resources, i.e., client 410. Each client identifies client 410 as the master device in the local machine.

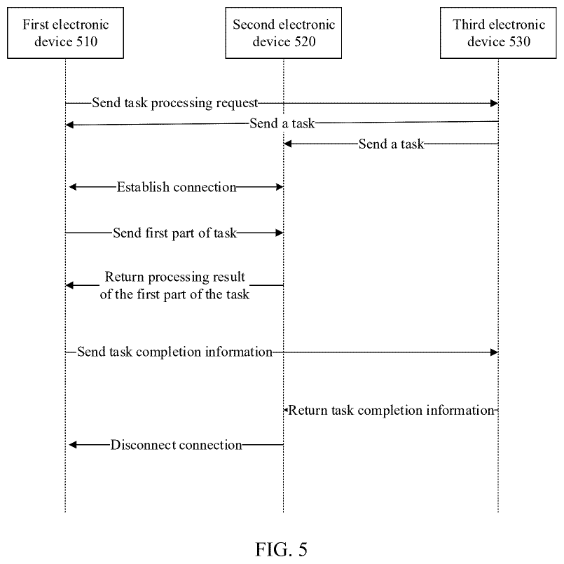

FIG. 5 is a timing diagram of a task processing method according to some embodiments of the present disclosure. With referring to FIG. 5, a processing sequence of task processing using the task processing method provided by the present disclosure is described in detail.

As shown in FIG. 5, after the first electronic device 510 receives the target processing task triggered by the target application, it sends the task processing request to the third electronic device 530. After the third electronic device 530 receives the task processing request sent by the first electronic device 510, the third electronic device 530 determines the at least one second electronic device 520 from the target device cluster and sends a task to the first electronic device 510, which is used to indicate each second electronic device 520 to the first electronic device 510. At the same time, the third electronic device 530 sends another task to each second electronic device 520, which is used to indicate the task machine (i.e., the first electronic device 510) corresponding to the target processing task that needs to be collaboratively processed to the corresponding second electronic device 520. Based on a device resource status of the at least one second electronic device allocated by the third electronic device 530, the first electronic device 510 sends the first part of the target processing task to the at least one second electronic device 520. After receiving the first part of the target processing task, the at least one second electronic device 520 uses device resources of the local device to process the first part of the target processing task, obtains a processing result of the first part of the target processing task, and returns the processing result to the first electronic device 510. After receiving the processing result of the first part of the target processing task, the first electronic device 510 sends task completion information to the third electronic device 530. After receiving the task completion information, the third electronic device 530 sends the task completion information to each second electronic device 520. The first electronic device 510 disconnects the communication connection with each second electronic device 520.

In the embodiments of the present disclosure, the target device cluster including the multiple electronic devices is established in a distributed application mode to facilitate the communication between the multiple electronic devices. The third electronic device is used as a comprehensive scheduling platform for the GPU resources, which achieves dynamic monitoring and management of the GPU resource status of the multiple electronic devices in the target device cluster, thereby achieving efficient utilization of the GPU resources in the target device cluster, and avoiding the impact of any single electronic device failure on the entire target device cluster. At the same time, the third electronic device dynamically allocates and adjusts the GPU resources of the multiple electronic devices in the target device cluster according to the computing requirements of different target processing tasks. After the target processing task is completed, the same GPU resources may be allocated to a subsequent target processing task, thereby avoiding idle computing power.

In some embodiments, the at least one second electronic device that can process the task processing request is determined at S103 through the third electronic device. S103 may be implemented by at least one of the following processes.

At S1031, if the task processing request carries target identification information, and the target identification information matches identification information of at least one electronic device in the target device cluster, the at least one electronic device matching the target identification information is determined as the at least one second electronic device.

Here, the target identification information refers to identification information of the target electronic device or the target GPU resource. The target electronic device or the target GPU resource is at least one electronic device or GPU resource specified by the first electronic device for processing the first part of the target processing task.

In some embodiments, the target identification information may include at least one of MAC address information, device name information, or other identification information of the target electronic device.

In some embodiments, the first part of the task includes a first subtask, and the first subtask is bound to a specified electronic device or GPU resource. For example, the electronic device with the highest efficiency in processing the first subtask may be pre-determined, and the electronic device may be bound to the first subtask. As such, when the target processing task includes the first subtask, the task processing request sent by the first electronic device to the third electronic device may carry the target identification information of the specified electronic device or GPU resource to inform the third electronic device of the required resource.

Therefore, when the target identification information matches the identification information of at least one electronic device in the target device cluster, the third electronic device determines the at least one electronic device corresponding to the target identification information based on the target identification information and the electronic device information in the target device cluster stored by the third electronic device, and determines the at least one electronic device pointed to by the target identification information as the at least one second electronic device to improve the task processing efficiency.

At S1032, if the task processing request carries the target identification information, but the target identification information cannot be matched in the target device cluster, the at least one second electronic device that can process the task processing request is determined based on the task processing request and the device resource status of each electronic device in the target device cluster.

In some embodiments, the third electronic device determines that the electronic device or GPU resource corresponding to the target identification information has not joined the target device cluster based on the target identification information and the electronic device information in the target device cluster stored by the third electronic device.

Here, the task processing request sent by the first electronic device to the third electronic device may include a total task amount required to process the target processing task, such as a total amount of calculations, such that the third electronic device determines the collaboration machine required by the first electronic device based on the total amount of calculations. Here, the total amount of calculations required to complete the target processing task is determined by the first electronic device based on its own computing resources.

In some embodiments, the device resource status of each electronic device in the target device cluster may include information such as a hardware configuration status of each electronic device, a total amount of device resources, and a used resource status.

In some embodiments, during the operation of the target device cluster, each electronic device periodically sends the device resource status of the local device to the third electronic device, such that the third electronic device can obtain an available resource status of each electronic device in a timely manner.

In some embodiments, the third electronic device sets a corresponding resource threshold for the device resource usage of each electronic device in the target device cluster. When the third electronic device determines that the device resource usage of a specific electronic device exceeds the corresponding resource threshold based on the device resource status of each electronic device, the third electronic device excludes the specific electronic device when determining the at least one second electronic device.

As such, the third electronic device determines the at least one second electronic device among the multiple electronic devices whose resource usage does not exceed the corresponding resource threshold.

In some embodiments, the third electronic device also determines the at least one second electronic device from the target device cluster based on the objective of achieving the highest processing efficiency of the target processing task. As such, the third electronic device determines an electronic device combination with the highest processing efficiency for the target processing task from each electronic device based on the computing power of each electronic device in the target device cluster as the at least one second electronic device.

At S1033, if the task processing request does not carry the target identification information, the at least one second electronic device that can process the task processing request is determined based on the task processing request and the device resource status of each electronic device in the target device cluster.

Here, when the task processing request does not carry the target identification information, the third electronic device no longer determines whether the identification information of each electronic device in the target device cluster is the same as the target identification information, but determines the at least one second electronic device based on the task processing request and the device resource status of each electronic device.

Similarly, the third electronic device may determine the at least one second electronic device based on whether the resource usage of each electronic device exceeds the resource threshold and the computing power of each electronic device. For details, reference can be made to the description of S1032, which will not be repeated herein.

In some embodiments, the first part of the target processing task is sent to the at least one second electronic device through the target communication connection such that the at least one second electronic device processes the first part of the task (that is, S102). S102 may be implemented as at least one of the following processes.

At S1021, when the at least one second electronic device is unique, the first part of the target processing task is directly sent to the unique second electronic device, such that the unique second electronic device and the first electronic device process the target processing task in parallel or serially.

Here, when the third electronic device assigns only one second electronic device to the first electronic device, the first electronic device directly sends the first part of the task to the one second electronic device.

In some embodiments, the first electronic device determines the second part of the target processing task to be processed by the local device from the target processing task based on the hardware configuration and computing resource of the local device, and determines the part of the target processing task other than the second part of the task as the first part of the target processing task.

In some embodiments, the target processing task may be processed in parallel by the first electronic device and the at least one second electronic device. After the at least one second electronic device completes the processing of the first part of the target processing task, it returns the processing result of the first part of the target processing task to the first electronic device. The first electronic device combines the processing result of the second part of the target processing task with the processing result of the first part of the target processing task.

In some embodiments, the target processing task may be processed serially by the first electronic device and the at least one second electronic device. That is, the first electronic device or the at least one second electronic device processes the corresponding part of the target processing task first, and then sends the processing result to the other electronic device, such that the other electronic device uses the processing result to perform the corresponding part of the target processing task. Here, an execution order of the first electronic device and the at least one second electronic device when performing serial processing is not limited.

In some embodiments, the first part of the target processing task includes multiple subtasks, and the second part of the target processing task also includes multiple subtasks. Therefore, when the first part of the target processing task and the second part of the target processing task are processed by the first electronic device and the at least one second electronic device, some of the subtasks may be processed serially by the first electronic device and the at least one second electronic device, and some of the subtasks may be processed in parallel by the first electronic device and the at least one second electronic device. The specific processing order may be determined based on the logical relationship of the multiple subtasks, which is not limited herein.

At S1022, when the at least one second electronic device is not unique, each subtask of the first part of the target processing task is sent to the corresponding second electronic device based on the device resource status of each second electronic device, such that the non-unique second electronic device and the first electronic device process the corresponding processing tasks in parallel or serially.

Here, when the at least one second electronic device assigned by the third electronic device to the first electronic device is not unique, based on the device resource status of each second electronic device, the first part of the target processing task is split into multiple subtasks and sent to the corresponding second electronic device respectively.

In some embodiments, when the third electronic device sends the information of multiple second electronic devices to the first electronic device, the hardware configuration and available resource status of each second electronic device are sent to the first electronic device at the same time. The first electronic device splits the second part of the target processing task into multiple subtasks based on the hardware configuration and available resource status of each second electronic device, and assigns the multiple subtasks to the corresponding second electronic device for processing.

In some embodiments, the third electronic device determines the multiple second electronic devices for the first electronic device based on the amount of computation required for the target processing task in the task processing request sent by the first electronic device, splits the target processing task into the second part of the target processing task and the first part of the target processing task based on the hardware configuration and available resources of the first electronic device and each second electronic device, and splits the first part of the target processing task into multiple subtasks corresponding to each second electronic device. Thereafter, the third electronic device sends the information of the multiple second electronic devices, splitting information of the target processing task, and the correspondence between the multiple subtasks of the first part of the target processing task and each second electronic device to the first electronic device, such that the first electronic device splits and distributes the target processing task under the control of the third electronic device.

In some embodiments, for the manner in which the multiple second electronic devices and the first electronic device process the corresponding processing tasks in parallel or serially, reference can be made to the description of S1021, which will not be repeated herein.

At S104, the processing result of the first part of the target processing task fed back by the at least one second electronic device and the processing result of the second part of the target processing task are integrated before being fed back to the target application.

Here, after the at least one second electronic device completes the processing of the first part of the target processing task, it returns the processing result of the first part of the target processing task to the first electronic device.

Based on the logical relationship between the first part and the second part of the target processing task, the first electronic device integrates the processing result of the second part of the target processing task processed locally and the processing result of the first part of the target processing task received from the at least one second electronic device, obtains the processing result of the target processing task, and feeds back the processing result of the target processing task to the target application.

At S105, a task completion notification is sent to the at least one second electronic device through the third electronic device to disconnect the target communication connection with the at least one second electronic device.

Here, after the first electronic device receives the processing result of the first part of the target processing task fed back by the at least one second electronic device, the first electronic device sends the task completion notification to the third electronic device. Further, the third electronic device sends the task completion notification to each second electronic device to disconnect the target communication connection between the first electronic device and each second electronic device.

In some embodiments, the task processing method provided by the present disclosure further includes the following process S106 before sending the first part of the target processing task to the at least one second electronic device through the target communication connection (i.e., S102).

At S106, the target application's call request to the GPU of the first electronic device is intercepted through a first graphics library interface, and the target processing task is divided into the first part of the target processing task and the second part of the target processing task based on the device resource status of the first electronic device.

Here, the first graphics library interface (graphics library API) is a pre-generated interface file for calling the hardware resources of an electronic device (i.e., image processor resources or GPU resources), which is often in the form of a function for a user to call. In some embodiments, the first graphics library interface includes CUDA, DirectX (Direct EXtension X, DX), Open Graphics Library (OpenGL), Open Computing Language (OpenCL), etc.

In some embodiments, by intercepting the target application's call request to the local GPU resource through the first graphics library interface, the target processing task is obtained and the calculation amount information required for the target processing task is calculated. In some embodiments, a Hook mechanism may be used to hook an event that the application calls the local GPU resource through the first graphics library interface. Once the event occurs, the event is notified to a program for executing the task processing method of the present disclosure to capture the call request. For example, the first electronic device uses the Hook mechanism to intercept the target application calling the CUDA API.

Here, the process of interception using the Hook mechanism is described as follows. First, a target function is analyzed. Before implementing the Hook interception, the operation principle and usage scenario of the target function (including various process parameters, functions, and driver layer functions) in the target graphics library are analyzed in detail. The input, the output, the call sequence, and dependency of target data are determined to ensure that the Hook interception does not destroy the original logic.

Second, code injection is performed. Here, after analyzing the target function, a Hook processing function is injected into the target process (for example, the graphics rendering program of WDDM).

Third, the function is intercepted. The Hook processing function needs to intercept specific function calls in the target process and modify the entry point of the target function to point to the Hook processing function. In WDDM rendering driver, these functions are functions related to graphics rendering, window management, etc.

Fourth, the target function call is processed and forwarded. When the target function is called, control is transferred to a Hook handler. The Hook handler performs custom operations on the intercepted function call, such as modifying parameters, logging, or performing other operations. Then, the Hook handler calls the original target function and returns results to the caller.

Fifth, an original state is restored. The Hook handler needs to restore the original entry point of the target function after completing the interception operation to avoid affecting the normal operation of the target process.

In addition, the following tuning items are executed for the Hook mechanism.

First, error handling and resource management are taken care of. In the Hook handler, possible errors are properly handled to ensure that resources (such as memory, file handles, etc.) are properly managed. Problems such as memory leaks and handle leaks are avoided to reduce the risk of causing crashes.

Second, moderate synchronization and thread safety are taken care of. If the Hook interception involves multithreading, it needs to be ensured that the Hook handler is thread-safe. Synchronization mechanisms (such as mutexes, semaphores, etc.) may be used when necessary. But excessive synchronization needs to avoid to prevent performance degradation or deadlock.

Third, testing and verification are performed. Before implementing the Hook interception, the behavior of the Hook handler needs to be tested in various scenarios. It needs to be verified that the Hook interception will not cause the target program and system to crash, ensuring its compatibility and stability.

Fourth, monitoring and debugging are performed. After implementing the Hook interception, it needs to be monitored continuously. Key events and performance indicators need to be recorded for debugging and optimization when problems occur.

In some embodiments, the first electronic device monitors the local GPU resource usage in real time through a GPU monitoring program.

As such, the first electronic device determines that the local available GPU resources cannot meet the required computing amount of the target processing task based on the local GPU resource usage and the computing amount required for the target processing task, and then splits the target application's call request to the first graphics library (that is, the target processing task) to obtain the first part of the target processing task and the second part of the target processing task. The second part of the target processing task is processed using the local GPU resources of the first electronic device.

In some embodiments, the interception of the target application's call request to the GPU of the first electronic device through the first graphics library interface at S106 may be implemented by the following process S1061.

At S1061, the call request sent by the target application from the user mode of the graphics driver model to its kernel mode after the first graphics library interface is intercepted

Here, the graphics driver model is a software used to control graphics hardware, which runs in the user mode and the kernel mode.

The user mode is mainly responsible for processing graphics library interface calls and converting these call requests into GPU commands for controlling the GPU driver. The kernel mode is mainly responsible for interacting with the operating system kernel, managing GPU resources, and scheduling GPU tasks.

The call request sent by the target application to the kernel mode through the user mode of the graphics driver module after the first graphics library interface refers to the call request for the GPU hardware driver sent by the first graphics library interface to the kernel mode based on the call request of the target application after the target application calls the first graphics library interface in the user mode.

In some embodiments, the call request may be intercepted by using the Hook mechanism.

Afterwards, the first electronic device uses the intercepted call request for the GPU hardware driver as the target processing task, and splits the call request into a first part of the call request (corresponding to the first part of the target processing task) and a second part of the call request (corresponding to the second part of the target processing task) based on the local hardware configuration and resource usage.

Correspondingly, the sending of the first part of the target processing task to the at least one second electronic device through the target communication connection (i.e., S102) may be implemented as the following process S1023.

At S1023, the first part of the target processing task is sent to the at least one second electronic device after encoding processing, and the second part of the target processing task is passed to the graphics processor driver layer of the first electronic device for subsequent processing.

Here, after the first part of the target processing task is compiled and processed, it is sent to the at least one second electronic device through the target communication connection to process the first part of the target processing task using the computing resources on each second electronic device.

At the same time, using the original GPU hardware resource call chain, the second part of the target processing task is passed to the local GPU driver layer of the first electronic device to process it using the local GPU hardware resources.

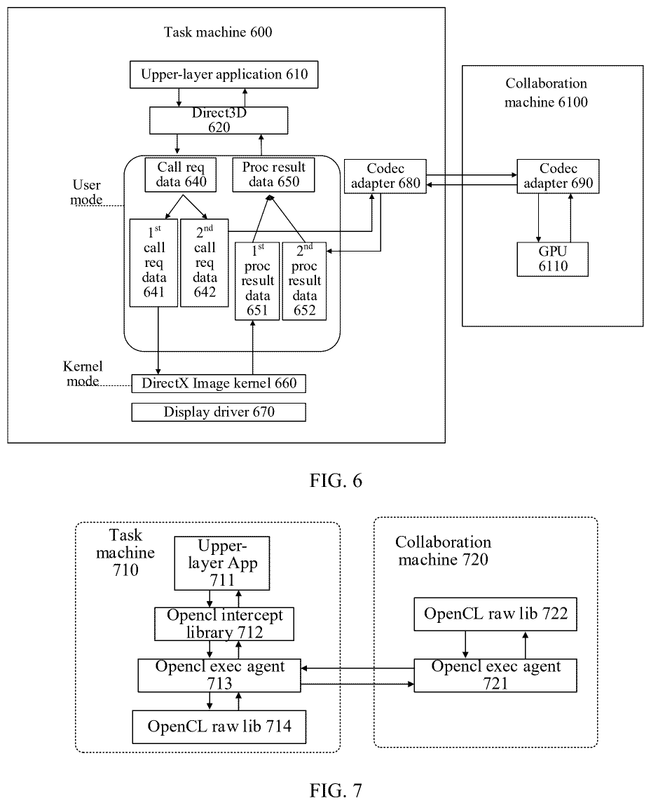

As shown in FIG. 6, in the scenario where the image driver model is the Microsoft Graphics Driver Model (Windows Display Driver Model or WDDM), the process of using the task processing method provided in the embodiments of the present disclosure to process the target processing task is as follows.

In the task machine 600, the upper layer application 610 sends an interface call request to Direct3D 620. Here, an intermediate layer is added between the Direct3D 620 graphics library and the kernel mode to intercept the call request data 640 and split the call request data 640 into the first call request data 641 (corresponding to the second part of the target processing task) and the second call request data 642 (corresponding to the first part of the target processing task). The first call request data 641 is transmitted to the local DirectX image kernel 660, and is further processed by the local display driver 670 and the local GPU resources. The second call request data 642 is sent to the codec adapter 680 for encoding. After encoding by the codec adapter 680, the encoded second call request data 642 is sent to the codec adapter 690 at the collaboration machine 6100 through the communication interface. After decoding by the codec adapter 690, the decoded second call request data 642 is sent to the local GPU 6110 of the collaboration machine 6100 for performing task processing to obtain the processing result of the second call request data 642. The collaboration machine 6100 sends the processing result of the second call request data 642 to the codec adapter 690 for encoding, and sends the encoded processing result of the second call request data 642 to the codec adapter 680 on the task machine side for decoding to obtain the second processing result data 652. The first processing result data 651 corresponding to the first call request data 641 is obtained from the local display driver 670. The first processing result data 651 is merged with the second processing result data 652 to obtain the processing result data 650. The processing result data 650 is returned to the upper layer application 610 through Direct3D 620.

In some embodiments, the task processing method provided by the present disclosure further includes the following process S107 before sending the first part of the target processing task to the at least one second electronic device (i.e., S102) through the target communication connection.

At S107, the target application's call request to the first graphics library interface is intercepted through the second graphics library interface, and the call request is split into a first call request and at least one second call request based on the device resource situation of the first electronic device and the device resource status of other electronic devices in the target device cluster, to send the first call request to the first graphics library interface and send the at least one second call request to the third graphics library interface of the determined at least one second electronic device.

Here, the second graphics library interface is the same as the first graphics library interface and may be called by the target application.

In some embodiments, the second graphics library interface may be customized by using the graphics library interface header file declaration provided by a third-party service.

Here, when the target application calls the first graphics library interface, the target application's call request is intercepted by using the second graphics library interface, which is equivalent to the target application first calling the second graphics library interface. As such, the call request of the target application intercepted by the second graphics library interface is analyzed to determine the amount of calculation required for the target processing task of the target application, and then based on the hardware configuration and resource usage of the first electronic device, it is determined that the device resources of the first electronic device do not meet the computing power requirements of the target processing task. Afterwards, the first electronic device splits the call request of the target application (i.e., the target processing task) into the first call request (i.e., the second part of the target processing task) and the at least one second call request (i.e., the first part of the target processing task) based on the local device resource status and the device resource status of other electronic devices in the target device cluster (i.e., the hardware configuration and available resource status), and sends each second call request to the third graphics library interface of the corresponding second electronic device.

Here, the third graphics library interface of the second electronic device may be a graphics library interface similar to the first graphics library interface, such that the third graphics library interface can correctly process the second call request. In some embodiments, a hardware resource monitoring application is provided in the first electronic device and each second electronic device. The hardware resource monitoring application is used to monitor the hardware resource usage in the corresponding electronic device.

In some embodiments, the first electronic device may periodically receive corresponding hardware resource usage information from each second electronic device to determine the second call request allocated to each second electronic device based on the hardware resource usage information corresponding to each second electronic device.

In some embodiments, the first electronic device and each second electronic device will periodically send their respective corresponding hardware resource usage information to the master device in the target device cluster, such that the master device determines the call request allocated to each electronic device based on the hardware resource usage information corresponding to each electronic device.

FIG. 7 is a schematic diagram of applying a task processing method in coordinating a task machine and a collaboration machine to process a target processing task according to some embodiments of the present disclosure. As shown in FIG. 7, the upper-layer application 711 in the task machine 710 triggers the target processing task and issues a call request to the OpenCL interception library 712.

Here, the OpenCL interception library 712 is a graphics library formed by customizing the API interface logic using the OpenCL API header file declaration provided by a third-party service. When in use, the OpenCL interception library 712 is connected to the service discovery subsystem to replace the OpenCL raw library 714 in the operating system and support the call of the OpenCL interception library 712 by third-party applications. Here, in the operating system, the OpenCL raw library 714 file is renamed to OpenCL_raw.dll. Therefore, when the upper-layer application 711 calls the OpenCL raw library 714, the call request of the upper-layer application 711 is intercepted by the OpenCL interception library 712.

Then, the OpenCL interception library 712 sends the intercepted call request to the OpenCL execution agent 713, and the OpenCL execution agent 713 splits the intercepted call request based on the device resource status of the task machine 710 and the device resource status of other electronic devices in the target device cluster, that is, splits it into a first call request and at least one second call request.

Afterwards, the OpenCL execution agent 713 sends the first call request to the OpenCL raw library 714 of the task machine. GPU instructions are sent to the local GPU driver through the OpenCL raw library 714. The local computing resources are used to process the first call request to obtain the processing result of the first call request. At the same time, the OpenCL execution agent 713 sends the at least one second call request to the OpenCL execution agent 721 of the corresponding collaboration machine 720. The OpenCL execution agent 721 of the collaboration machine 720 sends the at least one second call request to the local OpenCL raw library 722. The local OpenCL raw library 722 sends GPU instructions to the local GPU driver. Local computing resources are used to process the at least one second call request to obtain the processing result of the at least one second call request. The OpenCL execution agent 721 of the collaboration machine 720 returns the processing result of the at least one second call request to the OpenCL execution agent 713 of the task machine 710. At the same time, the OpenCL execution agent 713 of the task machine 710 obtains the processing result of the first call request from the local OpenCL raw library 714, merges the processing result of the first call request and the processing result of the at least one second call request, and returns them to the upper-layer application 711.

In some embodiments, the task processing method provided by the present disclosure further includes the following process S108 before sending the first part of the target processing task to the at least one second electronic device through the target communication connection (i.e., S102).

At S108, the call request of the target application to the first graphics library interface is intercepted through the second graphics library interface, the call request is split into at least one second call request based on the device resource status of the target device cluster, and the at least one second call request is sent to the determined third graphics library interface of the at least one second electronic device.

Here, for the description of the first graphics library interface, the second graphics library interface, and the third graphics library interface, reference can be made to the description of the first graphics library interface, the second graphics library interface, and the third graphics library interface in the description of S107, which will not be repeated herein.

In some embodiments, after the first electronic device intercepts the call request of the target application, the first electronic device splits the call request into the at least one second call request (corresponding to the first part of the target processing task) based only on the device resource status in the target device cluster, and sends each second call request to the third graphics library interface of the corresponding second electronic device. That is, the first electronic device only issues tasks as the task machine, but does not perform any task processing.

In some embodiments, after the first electronic device intercepts the call request of the target application, the call request and the required computing amount are sent to the master device in the target device cluster. The master device determines the at least one second electronic device from the target device cluster based on the device resource status of each electronic device in the target device cluster. Based on the device resource status of each second electronic device, the call request received from the first electronic device is split into the at least one second call request. Then, each second call request is sent to the corresponding second electronic device.

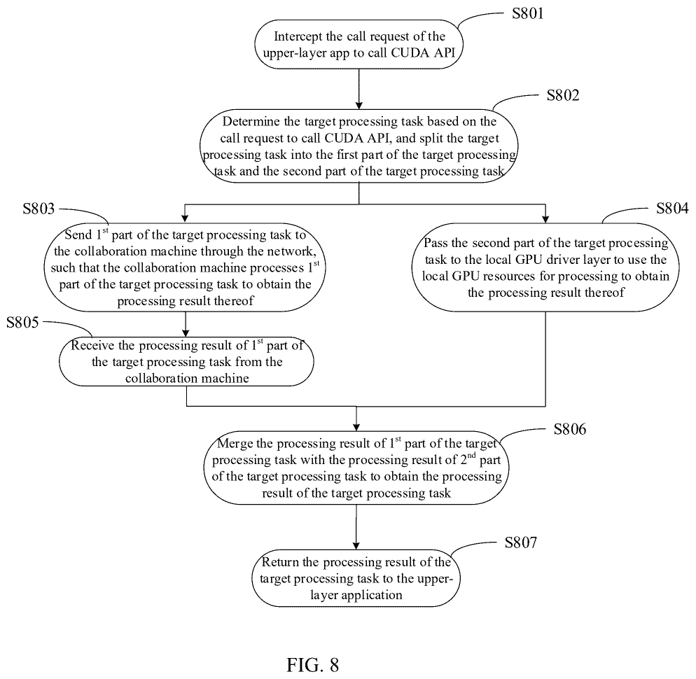

FIG. 8 is a flowchart of another task processing method according to some embodiments of the present disclosure. The task machine is the first electronic device and the collaboration machine is the at least one second electronic device. As shown in FIG. 8, the task processing method includes the following processes S801 to S807.

At S801, the call request of the upper-layer application to call the CUDA API is intercepted. The processing proceeds to S802.

At S802, the target processing task is determined based on the call request to call the CUDA API, and the target processing task is split into the first part of the target processing task and the second part of the target processing task. The process then proceeds to S803 and S804.

At S803, the first part of the target processing task is sent to the collaboration machine through the network, such that the collaboration machine processes the first part of the target processing task to obtain the processing result of the first part of the target processing task. The process then proceeds to S805.

At S804, the second part of the target processing task is passed to the local GPU driver layer to use the local GPU resources for processing to obtain the processing result of the second part of the target processing task. The process then proceeds to S806.

At S805, the processing result of the first part of the target processing task is received from the collaboration machine. The process then proceeds to S806.

At S806, the processing result of the first part of the target processing task is merged with the processing result of the second part of the target processing task to obtain the processing result of the target processing task. The process then proceeds to S807.

At S807, the processing result of the target processing task is returned to the upper-layer application.

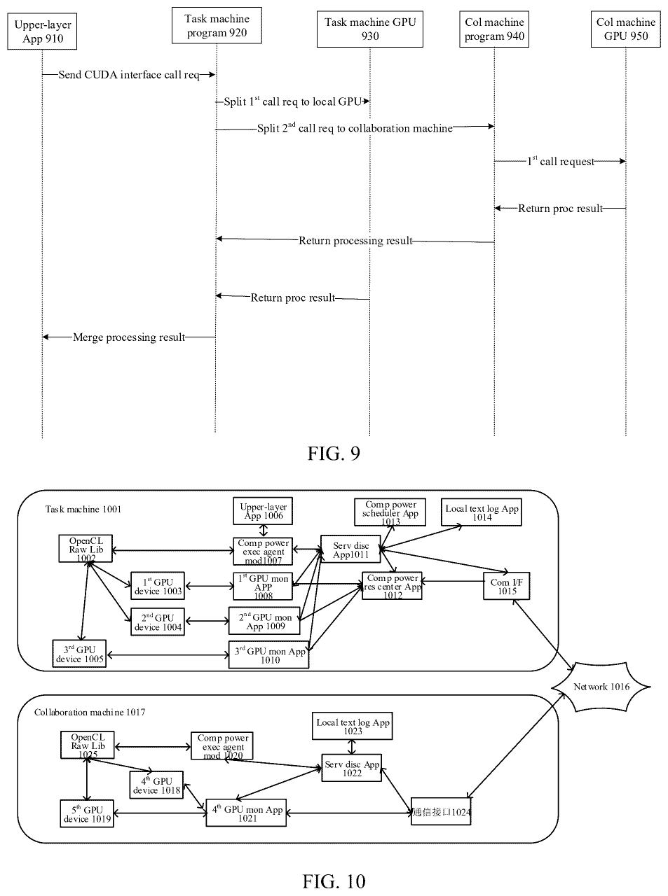

FIG. 9 is a timing diagram of another task processing method according to some embodiments of the present disclosure. In the timing relationship diagram shown in FIG. 9, the task machine is the first electronic device. The collaboration machine is the at least one second electronic device. The upper-layer application is the application running on the task machine. The task machine GPU is the local GPU resource of the task machine. The task machine program is the application running on the task machine for executing the task processing method provided in the present disclosure. The collaboration machine program is the application running on the collaboration machine for executing the task processing method provided in the present disclosure. The collaboration machine GPU is the local GPU resource of the collaboration machine.

As shown in FIG. 9, the upper-layer application 910 sends the interface call request to CUDA. The task machine program 920 intercepts the CUDA interface call request of the upper-layer application 910 and splits the CUDA interface call request into the first call request and the second call request. The task machine program 920 sends the first call request to the task machine GPU 930 to use the local GPU resources of the task machine for processing.

The task machine program 920 sends the second call request to the collaboration machine program 940. The collaboration machine program 940 sends the second call request to the collaboration machine GPU 950 to use the collaboration machine GPU 950 for task processing. The collaboration machine GPU 950 returns the processing result of the second call request to the collaboration machine program 940. The collaboration machine program 940 returns the processing result of the second call request to the task machine program 920. The task machine GPU 930 returns the processing result of the first call request to the task machine program 920. The task machine program 920 merges the processing result of the first call request with the processing result of the second call request, and returns the merged processing result to the upper-layer application 910.

FIG. 10 is a schematic structural diagram of a task processing system for performing a task processing method according to some embodiments of the present disclosure.

As shown in FIG. 10, after the computing power execution agent module 1007 in the task machine 1001 accesses the service discovery application 1011, the computing power execution agent module 1007 intercepts the call request of the upper-layer application 1006. In combination with the computing power scheduler application 1013, according to the device resource status of the task machine 1001 and the device resource status of at least one collaboration machine 1017 stored in the computing power resource center application 1012, the computing power execution agent module 1007 determines to split the call request into the first call request and the second call request. The first call request is used to send to the OpenCL raw library 1002, and the second call request is sent to the collaboration machine 1017 through the communication interface 1015. The OpenCL raw library 1002 is used to receive the first call request sent by the computing power execution agent module 1007. The GPU resources of the first GPU device 1003, the second GPU device 1004, and the third GPU device 1005 are used to process the first call request to obtain the processing result of the first call request.

The first GPU monitoring application 1008, the second GPU monitoring application 1009, and the third GPU monitoring application 1010 are used to monitor the computing power resource status of the first GPU device 1003, the second GPU device 1004, and the third GPU device 1005, respectively, and periodically send the computing power resource status of the first GPU device 1003, the second GPU device 1004, and the third GPU device 1005 to the computing power resource center application 1012.

The computing power resource center application 1012 is used to monitor the computing power resource status of the first GPU device 1003, the second GPU device 1004, and the third GPU device 1005, and send the computing power resource status to the computing power scheduler application 1013 when the computing power scheduler application 1013 requests to obtain the computing power resource status.

The service discovery application 1011 is used to manage the accessed services, and when there is an upper-layer application requesting a service, it can quickly establish a connection between the upper-layer application and the related service.

The local text log application 1014 may quickly access the service discovery application 1011 to facilitate text log data recording and storage. The local text log application 1014 may also facilitate automatic overwriting of expired logs.

The collaboration machine 1017 may receive the corresponding second call request from the task machine 1001 through the network 1016 and the communication interface 1024.

The computing power execution agent module 1020 in the collaboration machine 1017 receives the second call request from the communication interface 1024, and further calls the OpenCL raw library 1025 in the collaboration machine 1017.

The OpenCL raw library 1025 in the collaboration machine 1017 may call the same GPU resources in the collaboration machine 1017 as the task machine 1001, for example, the fourth GPU device 1018 or the fifth GPU device 1019, to process the second call request to obtain the processing result of the second call request.

The fourth GPU monitoring application 1021 in the collaboration machine 1017 is used to monitor the computing power resource status of the fourth GPU device 1018 and the fifth GPU device 1019.

The local text log application 1023 in the collaboration machine 1017 may quickly access the service discovery application 1022 to facilitate the storage of text log data records. The local text log application 1023 may also facilitate the automatic overwriting of expired logs.

The task processing system of the task processing method may be used to implement the method described in various method embodiments. For technical details not disclosed in the embodiments of the task processing system of the present disclosure, reference can be made to the description of the method embodiments of the present disclosure for understanding.

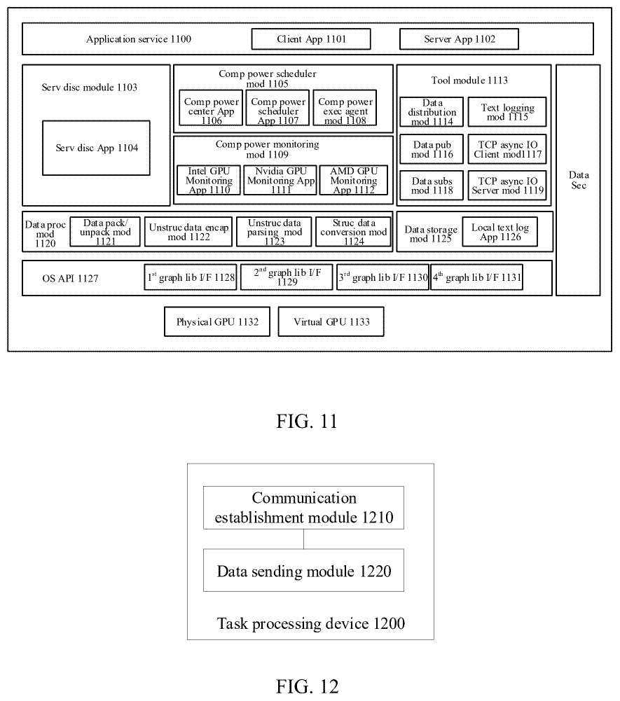

FIG. 11 is a schematic diagram of a software architecture of a task processing method according to some embodiments of the present disclosure.

As shown in FIG. 11, the application service 1100 in the software architecture includes a client application 1101 and a server application 1102.

Here, being loaded on the client, the client application 1101 may obtain the server computing power resource status and the local computing power resource status, schedule local computing power resource requests, send computing power collaboration requests to the server, and receive return data from the server, etc. The client application 1101 may quickly access the service discovery application 1104, establish and maintain a TCP session connection with the server on the client, and forward computing power resource scheduling requests, response results, and server computing power resource occupancy monitoring results and other data.

Being loaded on the server, the server application 1102 may subscribe to the local computing power resource status, assist the client in executing tasks, and return the execution results to the client, etc. The server application 1102 may quickly access the service discovery application 1104, manage all client TCP sessions connected to the server, and forward the computing resource scheduling requests, the response results, and the cloud computing resource occupancy monitoring results.

The service discovery application 1104 is included in the service discovery module 1103. When the services of the client or server are connected to the service discovery application 1104, they may be discovered by the upper-layer application.

Here, the service discovery application 1104 may quickly forward the message communication data between modules, persistently manage the identification and registration timestamp of each online module during the life cycle of the service discovery application, and support the query of online modules.

The computing power scheduling module 1105 includes a computing power resource center application 1106, a computing power scheduler application 1107, and a computing power execution agent module 1108.

The computing power resource center application 1106 may subscribe to the computing power resource status of local and server devices from the computing power monitoring module 1109, and synchronize, encapsulate, and publish the original data with different timestamps to the client application.

The computing power scheduler application 1107 may create a fast data forwarding, consumption, publishing, and subscription model, such that different applications can flexibly build models according to their business function requirements, meet the fast data interaction between applications and the load balancing of data transmission. The computing power scheduler application 1107 may split the call request of the upper-layer application based on the local computing power resource status and the server computing power resource status.

The computing power execution agent module 1108 may quickly access the service discovery application 1104 to receive the computing power resource call request of the upper-layer application during the operation of the service discovery application 1104, and perform resource scheduling according to the priority of local computing resources over the server computing resources and various GPU devices, and respond to the scheduling results.

The computing power monitoring module 1109 includes the first GPU monitoring application 1110, the second GPU monitoring application 1111, and the third GPU monitoring application 1112.

Here, the computing power monitoring module 1109 may quickly access the service discovery application 1104, automatically detect the computing power resource status and video memory occupancy rate of all GPU devices on the current physical/virtual computer during the operation of the service discovery application 1104, and encapsulate and publish the computing power resource status and occupancy rate data.

The first GPU monitoring application 1110, the second GPU monitoring application 1111, and the third GPU monitoring application 1112 are respectively used to monitor the computing power resource status of the corresponding GPU devices, and periodically send the computing power resource status of the GPU devices to the computing power resource center application 1106.

The tool module 1113 includes a data distribution module 1114, a text logging module 1115, a data publishing module 1116, a TCP asynchronous IO client module 1117, a data subscription module 1118, and a TCP asynchronous IO server module 1119, which are respectively used to perform data distribution, text logging, data publishing and subscription functions.

The TCP asynchronous IO client module 1117 and the TCP asynchronous IO server module 1119 are used to create listeners, connectors, transmitters, receivers, and TCP session models for asynchronous IO communication, such that different applications can flexibly build models according to their business function requirements to meet the rapid data interaction between applications.

At the data layer, the data processing module 1120 includes a data packaging/unpacking module 1121, an unstructured data encapsulation module 1122, an unstructured data parsing module 1123, and a structured data conversion module 1124.

The data storage module 1125 includes a local text log application 1126.

At the operating system layer, the operating system (OS) interface 1127 includes a first graphics library interface 1128, a second graphics library interface 1129, a third graphics library interface 1130, and a fourth graphics library interface 1131.

At the device layer, it includes a physical GPU 1132 and a virtual GPU 1133.

The present disclosure further provides a task processing device. The task processing device includes various units and the various modules included in various units, which may be implemented by a processor in a computer device. They may also be implemented by specific logic circuits. In the implementation process, the processor may be a central processing unit (CPU), a microprocessor (MPU), a digital signal processor (DSP) or a field programmable gate array (FPGA), etc.

FIG. 12 is a schematic structural diagram of a task processing device according to some embodiments of the present disclosure. As shown in FIG. 12, the task processing device 1200 includes: a communication establishment module 1210 and a data sending module 1220. The communication establishment module 1210 may establish a target communication connection with the at least one second electronic device determined from the target device cluster in response to the first electronic device in the target device cluster obtaining the target processing task triggered by the target application. The data sending module 1220 may send the first part of the target processing task to the at least one second electronic device through the target communication connection, such that the at least one second electronic device processes the first part of the target processing task. The first part of the target processing task is the remaining task in the target processing task except the second part of the target processing task processed by the first electronic device, and the target device cluster is a resource cluster including multiple electronic devices.

In some embodiments, the data sending module 1220 may also: send the task processing request to the third electronic device to determine the at least one second electronic device that can process the task processing request through the third electronic device. The third electronic device is a device determined from the target device cluster.

In some embodiments, the data sending module 1220 may also perform at least one of the following. If the task processing request carries the target identification information, and the target identification information matches the identification information of at least one electronic device in the target device cluster, the at least one electronic device matching the target identification information is determined as the at least one second electronic device. If the task processing request carries the target identification information, but the target identification information cannot be matched in the target device cluster, the at least one second electronic device capable of processing the task processing request is determined based on the task processing request and the device resource status of each electronic device in the target device cluster. If the task processing request does not carry the target identification information, the at least one second electronic device capable of processing the task processing request is determined based on the task processing request and the device resource status of each electronic device in the target device cluster.

In some embodiments, the data sending module 1220 may also perform at least one of the following. When the at least one second electronic device includes a second electronic device, the first part of the target processing task is directly sent to the second electronic device, such that the second electronic device and the first electronic device process the target processing task in parallel or in series. When the at least one second electronic device includes multiple second electronic devices, each subtask of the first part of the target processing task is sent to the corresponding second electronic device based on the device resource status of each second electronic device, such that the multiple second electronic devices and the first electronic device process the corresponding target processing task in parallel or in series.

In some embodiments, the task processing device 1200 may also include a feedback module 1230 and/or a communication establishment module 1210. The feedback module 1230 is configured to integrate the processing result of the first part of the target processing task fed back by the at least one second electronic device and the processing result of the second part of the target processing task and then feed it back to the target application. The communication establishment module 1210 is configured to send the task completion notification to the at least one second electronic device through the third electronic device to disconnect the target communication connection with the at least one second electronic device.

In some embodiments, the task processing device 1200 further includes an interception module 1240. The interception module 1240 is configured to intercept the target application's call request to the GPU of the first electronic device through the first graphics library interface, and divide the target processing task into the first part of the target processing task and the second part of the target processing task based on the device resource status of the first electronic device.

In some embodiments, the interception module 1240 is also configured to intercept the call request sent by the target application from the user mode of the graphics driver model to its kernel mode after the first graphics library interface. Correspondingly, the data sending module 1220 is configured to send the first part of the target processing task to the at least one second electronic device after encoding processing, and pass the second part of the target processing task to the graphics processor driver layer of the first electronic device for subsequent processing.

In some embodiments, the interception module 1240 is also configured to intercept the target application's call request to the first graphics library interface through the second graphics library interface, and split the call request into the first call request and the at least one second call request based on the device resource status of the first electronic device and the device resource status of other electronic devices in the target device cluster, to send the first call request to the first graphics library interface and send the at least one second call request to the third graphics library interface of the determined at least one second electronic device.

In some embodiments, the interception module 1240 is also configured to intercept the target application's call request to the first graphics library interface through the second graphics library interface, and split the call request into the at least one second call request based on the device resource status of the target device cluster to send the at least one second call request to the third graphics library interface of the determined at least one second electronic device.

The description of the device embodiments is similar to the description of the method embodiments. The task processing device has similar beneficial effects as the task processing method. In some embodiments, the functions or modules included in the task processing device provided in the embodiments of the present disclosure may be used to execute the task processing method described in the method embodiments. For technical details not disclosed in the device embodiments of the present disclosure, reference can be made to the description of the method embodiments of the present disclosure for understanding.

It should be noted that in the embodiments of the present disclosure, if the task processing method is implemented in the form of a software function module and sold or used as an independent product, it can also be stored in a computer-readable storage medium. Based on this understanding, the technical solution of the embodiments of the present disclosure may be essentially or partly embodied in the form of a software product that contributes to the relevant technology. The software product is stored in a storage medium, including a plurality of instructions to enable a computer device (which can be a personal computer, server, or network device, etc.) to execute all or part of the methods described in each embodiment of the present disclosure. The storage medium includes: a U disk, a mobile hard disk, a read-only memory (ROM), a disk or optical disk, etc., which can store program code. As such, the embodiments of the present disclosure is not limited to any specific hardware, software or firmware, or any combination of hardware, software, and firmware.

The present disclosure also provides a computer device. The computer device includes a memory and a processor. The memory stores a computer program that can be run on the processor, and the processor implements some or all of the processes in the task processing method when executing the program.

The present disclosure also provides a computer-readable storage medium, on which a computer program is stored. The computer program implements some or all of the processes in the task processing method when executed by the processor. The computer-readable storage medium may be transient or non-transient.

The present disclosure also provides a computer program, including a computer-readable code. When the computer-readable code is executed in a computer device, a processor in the computer device executes to implement some or all of the processes in the task processing method.

The present disclosure also provides a computer program product, including a non-transient computer-readable storage medium storing a computer program. When the computer program is read and executed by a computer, some or all of the processes in the task processing method are implemented. The computer program product may be implemented in hardware, software or a combination thereof. In some embodiments, the computer program product is specifically embodied as a computer storage medium, and in some other embodiments, the computer program product is specifically embodied as a software product, such as a software development kit (SDK) and the like. It should be noted here that the description of each embodiment above tends to emphasize the differences between the embodiments, and the same or similar aspects can be referenced to each other. The description of the task processing device, storage medium, computer program and computer program product embodiments is similar to the description of the task processing method embodiments, and has similar beneficial effects as the method embodiments. For technical details not disclosed in the embodiments of the task processing device, storage medium, computer program and computer program product of the present disclosure, reference can be made to the description of the method embodiments of the present disclosure for understanding.

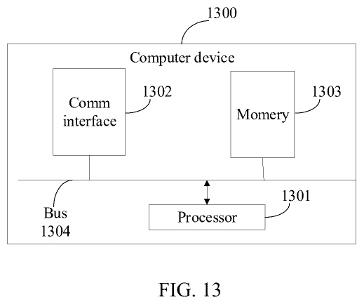

FIG. 13 is a schematic diagram of a hardware architecture of a computer device according to some embodiments of the present disclosure. As shown in FIG. 13, the hardware architecture of the computer device 1300 includes: a processor 1301, a communication interface 1302, and a memory 1303. The processor 1301 generally controls the overall operation of the computer device 1300.

The communication interface 1302 enables the computer device 1300 to communicate with other terminals or servers through a network. The memory 1303 is configured to store instructions and application programs executable by the processor 1301, and may also cache data to be processed or processed by the processor 1301 and each module in the computer device 1300 (for example, image data, audio data, voice communication data and video communication data). The memory 1303 may be implemented by a flash memory (FLASH) or a random-access memory (RAM). Data transmission between the processor 1301, the communication interface 1302, and the memory 1303 may be carried out through the bus 1304.

It should be understood that the “one embodiment” or “some embodiments” mentioned throughout the specification means that the specific features, structures or characteristics related to the embodiment or embodiments are included in at least one embodiment of the present disclosure. Therefore, “in one embodiment” or “in some embodiments” appearing throughout the specification does not necessarily refer to the same embodiment or embodiments. In addition, these specific features, structures or characteristics may be combined in one or more embodiments in any suitable manner. It should be understood that in various embodiments of the present disclosure, the size of the serial number of each step/process mentioned above does not mean the order of execution. The execution order of each step/process should be determined by its function and internal logic, and should not constitute any limitation on the implementation process of the embodiments of the present disclosure. The serial number of the embodiments of the present disclosure is merely for the description and does not represent the advantages and disadvantages of the embodiments.

It should be noted that in this specification, the term “include”, “comprise” or any other variant thereof is intended to cover non-exclusive inclusion, such that a process, method, article or device including a series of elements includes not only those elements, but also other elements not explicitly listed, or also includes elements inherent to such a process, method, article or device. In the absence of further restrictions, an element defined by the sentence “including a . . . ” does not exclude the existence of other identical elements in the process, method, article or device including the element.

In the embodiments provided in the present disclosure, it should be understood that the disclosed devices and methods may be implemented in other ways. The device embodiments described above are only schematic. For example, the division of the units/modules is only a logical function division. There may be other division methods in actual implementation, such as, multiple units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of the embodiments.

In addition, all functional units in the embodiments of the present disclosure may be integrated into one processing unit, or each unit may be separately used as a unit, or two or more units may be integrated into one unit. The integrated unit may be implemented in the form of hardware or in the form of hardware plus software functional units.

A person skilled in the art can understand that all or part of the steps/processes of implementing the method embodiments may be completed by hardware related to program instructions, and the program instructions may be stored in a computer-readable storage medium. When the program is executed, the steps/processes of the method embodiments are executed. The storage medium may include a mobile storage device, a read-only memory (ROM), a disk or an optical disk, and other media that can store program instructions.

Alternatively, if the integrated unit of the present disclosure is implemented in the form of a software functional module and sold or used as an independent product, it may also be stored in a computer-readable storage medium. Based on this understanding, the technical solution of the present disclosure, or the part that contributes to the relevant technology, may be embodied in the form of a software product. The computer software product is stored in a storage medium, including a plurality of instructions to enable a computer device (which can be a personal computer, server, or network device, etc.) to execute all or part of the methods described in each embodiment of the present disclosure. The storage medium includes various media that can store program instructions, such as mobile storage devices, ROMs, magnetic disks or optical disks.

The above is merely an implementation method of the present disclosure, but the protection scope of the present disclosure is not limited thereto. An ordinary person skilled in the art can easily think of modifications or replacements within the technical scope disclosed in the present disclosure, which should be covered within the protection scope of the present disclosure.

What is claimed is:

1. A task processing method, comprising:
in response to a first electronic device in a target device cluster obtaining a target processing task triggered by a target application, establishing a target communication connection with at least one second electronic device determined from the target device cluster; and
sending a first part of the target processing task to the at least one second electronic device through the target communication connection, such that the at least one second electronic device processes the first part of the target processing task;
wherein the first part of the target processing task is the remaining task in the target processing task except a second part of the target processing task processed by the first electronic device, and the target device cluster is a resource cluster including multiple electronic devices.

2. The method according to claim 1, further comprising:
sending a task processing request to a third electronic device to determine the at least one second electronic device capable of processing the task processing request through the third electronic device, wherein the third electronic device is a device determined from a target device cluster.

3. The method according to claim 2, wherein determining the at least one second electronic device capable of processing the task processing request through the third electronic device comprises at least one of:
in response to the task processing request carrying target identification information, and the target identification information matching identification information of at least one electronic device in the target device cluster, determining the at least one electronic device matching the target identification information as the at least one second electronic device;
in response to the task processing request carrying the target identification information, but the target identification information not being matched in the target device cluster, determining the at least one second electronic device capable of processing the task processing request based on the task processing request and a device resource status of each electronic device in the target device cluster; or
in response to the task processing request not carrying the target identification information, determining the at least one second electronic device capable of processing the task processing request based on the task processing request and the device resource status of each electronic device in the target device cluster.

4. The method according to claim 1, wherein sending the first part of the target processing task to the at least one second electronic device through the target communication connection such that the at least one second electronic device processes the first part of the target processing task comprises at least one of:
in response to the at least one second electronic device being unique, directly sending the first part of the target processing task to the unique second electronic device such that the unique second electronic device and the first electronic device process the target processing task in parallel or in series; or
in response to the second electronic device being not unique, sending subtasks of the first part of the target processing task to the corresponding second electronic device based on a device resource status of each second electronic device such that the non-unique second electronic devices and the first electronic device process corresponding processing tasks in parallel or in series.

5. The method according to claim 1, further comprising:
merging a processing result of the first part of the target processing task fed back by the at least one second electronic device and a processing result of the second part of the target processing task and then feeding it back to the target application; and/or
sending a task completion notification to the at least one second electronic device through a third electronic device to disconnect the target communication connection with the at least one second electronic device.

6. The method according to claim 1, further comprising:
intercepting a target application's call request to a GPU of the first electronic device through a first graphics library interface, and dividing the target processing task into the first part of the target processing task and the second part of the target processing task based on a device resource status of the first electronic device.

7. The method according to claim 6, wherein:
intercepting the target application's call request to the GPU of the first electronic device through the target graphics library interface includes intercepting a call request sent by the target application to its kernel mode through a user mode of a graphics driver model after the first graphics library interface; and
correspondingly, sending the first part of the target processing task to the at least one second electronic device through the target communication connection includes sending the first part of the target processing task to the at least one second electronic device after encoding, and passing the second part of the target processing task to a GPU driver layer of the first electronic device for subsequent processing.

8. The method according to claim 1, further comprising:
intercepting a target application's call request to a first graphics library interface through a second graphics library interface, and splitting the target application's call request into a first call request and at least one second call request based on a device resource status of the first electronic device and a device resource status of other electronic devices in the target device cluster, to send the first call request to the first graphics library interface and send the at least one second call request to a third graphics library interface of the at least one second electronic device.

9. The method according to claim 1, further comprising:
intercepting a target application's call request to a first graphics library interface through a second graphics library interface, and splitting the target application's call request into at least one second call request based on a device resource status of the target device cluster, to send the at least one second call request to a third graphics library interface of the at least one second electronic device.

10. A task processing device, comprising:
a memory storing program instructions; and
a processor coupled to the memory, wherein when being executed the processor, the program instructions cause the processor to:
in response to a first electronic device in a target device cluster obtaining a target processing task triggered by a target application, establish a target communication connection with at least one second electronic device determined from the target device cluster; and
send a first part of the target processing task to the at least one second electronic device through the target communication connection, such that the at least one second electronic device processes the first part of the target processing task;
wherein the first part of the target processing task is the remaining task in the target processing task except a second part of the target processing task processed by the first electronic device, and the target device cluster is a resource cluster including multiple electronic devices.

11. The device according to claim 10, wherein the processor is further configured to:
send a task processing request to a third electronic device to determine the at least one second electronic device capable of processing the task processing request through the third electronic device, wherein the third electronic device is a device determined from a target device

12. The device according to claim 11, wherein when determining the at least one second electronic device capable of processing the task processing request through the third electronic device, the processor is further configured to perform at least one of:
in response to the task processing request carrying target identification information, and the target identification information matching identification information of at least one electronic device in the target device cluster, determining the at least one electronic device matching the target identification information as the at least one second electronic device;
in response to the task processing request carrying the target identification information, but the target identification information not being matched in the target device cluster, determining the at least one second electronic device capable of processing the task processing request based on the task processing request and a device resource status of each electronic device in the target device cluster; or
in response to the task processing request not carrying the target identification information, determining the at least one second electronic device capable of processing the task processing request based on the task processing request and the device resource status of each electronic device in the target device cluster.

13. The device according to claim 10, wherein when sending the first part of the target processing task to the at least one second electronic device through the target communication connection such that the at least one second electronic device processes the first part of the target processing task, the processor is further configured to perform at least one of:
in response to the at least one second electronic device being unique, directly sending the first part of the target processing task to the unique second electronic device such that the unique second electronic device and the first electronic device process the target processing task in parallel or in series; or
in response to the second electronic device being not unique, sending subtasks of the first part of the target processing task to the corresponding second electronic device based on a device resource status of each second electronic device such that the non-unique second electronic devices and the first electronic device process corresponding processing tasks in parallel or in series.

14. The device according to claim 10, wherein the processor is further configured to:
merge a processing result of the first part of the target processing task fed back by the at least one second electronic device and a processing result of the second part of the target processing task and then feed it back to the target application; and/or
send a task completion notification to the at least one second electronic device through a third electronic device to disconnect the target communication connection with the at least one second electronic device.

15. The device according to claim 10, wherein the processor is further configured to:
intercept a target application's call request to a GPU of the first electronic device through a first graphics library interface, and divide the target processing task into the first part of the target processing task and the second part of the target processing task based on a device resource status of the first electronic device.

16. The device according to claim 15, wherein:
intercepting the target application's call request to the GPU of the first electronic device through the target graphics library interface includes intercepting a call request sent by the target application to its kernel mode through a user mode of a graphics driver model after the first graphics library interface; and
correspondingly, sending the first part of the target processing task to the at least one second electronic device through the target communication connection includes sending the first part of the target processing task to the at least one second electronic device after encoding, and passing the second part of the target processing task to a GPU driver layer of the first electronic device for subsequent processing.

17. The device according to claim 10, wherein the processor is further configured to:
intercept a target application's call request to a first graphics library interface through a second graphics library interface, and split the target application's call request into a first call request and at least one second call request based on a device resource status of the first electronic device and a device resource status of other electronic devices in the target device cluster, to send the first call request to the first graphics library interface and send the at least one second call request to a third graphics library interface of the at least one second electronic device.

18. The device according to claim 10, wherein the processor is further configured to:
intercept a target application's call request to a first graphics library interface through a second graphics library interface, and split the target application's call request into at least one second call request based on a device resource status of the target device cluster, to send the at least one second call request to a third graphics library interface of the at least one second electronic device.

19. A computer-readable storage medium storing computer instructions, wherein when being executed by a processor, the computer instructions cause the process to:
in response to a first electronic device in a target device cluster obtaining a target processing task triggered by a target application, establish a target communication connection with at least one second electronic device determined from the target device cluster; and
send a first part of the target processing task to the at least one second electronic device through the target communication connection, such that the at least one second electronic device processes the first part of the target processing task;
wherein the first part of the target processing task is the remaining task in the target processing task except a second part of the target processing task processed by the first electronic device, and the target device cluster is a resource cluster including multiple electronic devices.

20. The computer-readable storage medium according to claim 19, wherein the processor is further configured to:
send a task processing request to a third electronic device to determine the at least one second electronic device capable of processing the task processing request through the third electronic device, wherein the third electronic device is a device determined from a target device
